(19) United States
(12) Patent Application Publication
(10) Pub. No.: US 2020/0073210 A1
(43) Pub. Date: Mar. 5, 2020

(54) Method to help navigate users of mobile communication devices by re-directed camera views

(71) Applicant: Daniel Lai Chow Leung, Toronto (CA)

(72) Inventor: Daniel Lai Chow Leung, Toronto (CA)

(21) Appl. No.: 16/118,420

(22) Filed: Aug. 30, 2018

(51) Int. Cl. G03B 17/17; G03B 17/04; H04N 7/18; G08B 7/06

(52) U.S. Cl. CPC G03B 17/17; G08B 7/066; H04N 7/185; G03B 17/04

(57) ABSTRACT

The present invention is a method using a simple, light, collapsible device comprises a convex mirror with positioning mechanisms, attached in front of the rear camera of a mobile device within the field of view (FOV) of the camera, to re-direct the view of the foreground of the user to the camera, while the device is held in the “walking while texting” position of device held in half-extended upper extremities and eyes on the screen. These images are continuously captured wide-angle frontal views, and using existing feature of the operating system of the device, with or without software manipulation, become upright views of the immediate horizon on the screen, to aid the “walking while texting” and similar user navigate around obstacles and dangers while walking forward. This view can be displayed on a split screen, or used as a background of the screen output of any software.

### FIELD OF THE INVENTION

The present invention relates to safety aids for mobile communication device users who are “walking while texting” or similarly engaged. More particularly, the invention relates to using the camera on the mobile device with a correctly placed convex mirror to produce a wide angle frontal view on the screen to aid navigation.

### BACKGROUND OF INVENTION

Since the advent of compact hand-held touch-screen mobile communication devices, broad availability of various wireless networks, and good graphic user interfaces, immediate wireless short message exchanges are commonly used for communication between users. When these conversations become engaging, users often are reading or typing messages (texting) while walking, keeping the devices in their half-extended arms and bending their heads downward to read the contents of the screen. Users of other programs than messaging, such as video games, can be just as engaged. Most users hold the screens tilted, with the top ends of the devices about a few degrees to 60 degrees above the horizon. In these “walking while texting” positions, the obstacles above-ground and on the ground more than a step ahead are outside of their visual fields. While collisions with pedestrians and stationery objects cause minor injuries, walking into moving traffic have serious consequences, and has prompted some towns to install traffic lights on the ground just in front of the crossing, in an attempt to catch the attention of the “walking while texting” person.

Most mobile phones in the developed world have digital cameras, with lenses having an angular FOV of about 55 degrees, designed to produce images similar to how the human eye sees without significant distortion. Recent versions of these digital cameras have dedicated Graphic Processing Units (GPUs), allowing the conversion of camera views to images on the screen continuously and instantaneously, with control of transparency of images and merging of displays as standard built-in features. The speed of the messaging program is not altered by the continuous display from the camera, as the Central Processing Unit (CPU) of the device used for general program execution is hardly involved in the control of image displays.

Recent development in the operating systems of mobile devices allow devices to run two programs on the same screen, enabling simultaneous display of a graphic image and any selected program. A part of the screen can be dedicated to an instantaneous image from the camera, while the other part can be used to display the messages of the messaging software, or screen output from other programs. For older operating systems or as an alternate approach, immediate images from the camera can be displayed as a background for the display of the messaging software by simple alterations of the software. Display from other programs can be similarly modified.

The present designs of most “messaging” or “texting” programs display each text message sent and received inside a demarcated area on the screen with opaque background called a “text bubble”. All messages from the ongoing session are kept in sequence for immediate recall, and can be displayed in their respective “text bubbles” against an opaque background of the program. This opaque background and “text bubbles” can be made transparent by simple software modification when desired. Displays from other programs can be similarly modified.

The need for a method to aid mobile device users avoid accidents while they are walking and looking at the screens is recognized. United States Patent Application 20140085334, titled “Transparent Texting”, proposes using the existing rear-facing camera of a mobile device as an aid to “walking while texting” user, by presenting a view of the ground the camera is pointing at, without provision of the view in the direction the user is heading. Another disclosure, U.S. Pat. No. 9,571,803, also recognizes the need, and proposes an additional adjustable external camera to produce an image of the frontal view of the user on the screen.

In the related subject of re-direction of camera views using an adapter with reflective elements on mobile phones, there are prior art disclosures by Hurst in U.S. Pat. No. 9,019,420, Zhang in U.S. Pat. No. 7,967,513, Roman in U.S. Pat. No. 9,544,539, Rothschild in U.S. Pat. No. 9,128,243, and Singh in United States Patent Application 2011/0081946.

In U.S. Pat. No. 9,019,420, Hurst claims a removable optical system comprising either prisms or light pipes, to re-direct the camera view, with no provision for view selection, or an increased angular FOV of the camera. Both disclosures by Zhang and Roman are that of rigidly fixed periscopes to re-direct camera views. In U.S. Pat. No. 9,128,243, Rothschild employs plain mirrors adjustable in direction, to redirect camera views for stealth photographic purposes, with no alteration in the angular FOV of the camera. In United States Patent Application 2011/0081946, Singh proposes a system of two mirrors that redirects the camera view, and is capable of view angle variation, with no change in the angular FOV. All these patents employ designs with multiple reflective elements, are non-collapsible, not light-weight nor structurally simple, and without increase in the camera existing angular FOV.

In the aspect of redirecting the camera view using refractive optical elements, there are disclosures of attachments to mobile devices by Kessler in U.S. Pat. No. 9,654,675, and Knapton in Great Britain Patent 2512145.

In U.S. Pat. No. 9,654,675, Kessler's prism system employs both the refractive property of curved surfaces of transparent material and the internal reflective property of prisms, to redirect, invert, and extend the camera view to a maximum angular FOV of about 60 degrees utilizing material of the highest possible refractive index (FIG. 4D). This is about half the normal human FOV, and a 15 percent increase in the usual angular FOV of about 53 degrees in the average mobile device camera. In GB Patent 9019420, Knapton claims an adapter for recording sporting activities using a mobile phone by re-directing the frontal views, comprising one prism with two curved refractive surfaces and another element with one curved refractive surface. This design has a fixed direction of view, and based on the figure (FIG. 4) in the disclosure, provides less than 90 degrees of angular FOV. In summary, both designs employ prisms, which have the disadvantage of being non-collapsible and bulky, incapable of continuous variation in the direction of view, and provide limited increase in the angular FOV of the device camera lens, hence not optimal for “walking while texting” navigation.

### BRIEF DESCRIPTION OF THE DRAWING

FIG. 1 is a side view of a mobile communication device with the screen 101 facing up, and the rear surface 102 with rear camera lens 103 facing down. The basic embodiment of this invention comprises: base 111, fixed to the rear surface 102, and connected to friction hinge 112, the latter holding the mirror backing 113, on which the convex mirror 114 rests, at an adjustable angle. Images in the foreground of the mobile device are reflected by convex mirror 114 into camera lens 103.

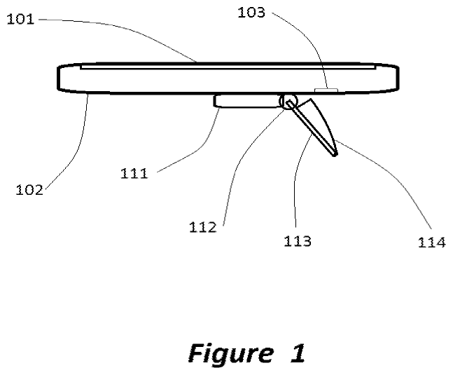

### DETAILED DESCRIPTION OF THE INVENTION

(Note that in this description, for simplicity, “mobile communication devices” is simplified as “mobile devices”; “angular field of view” is simplified as “angular FOV”; and “convex mirror or reflective surface” simplified as “convex mirror”.)

This invention aims to deliver a wide angular image of the foreground to the screen of a mobile device user by re-directing the view of the downward pointing camera, using an adaptor that is light-weight, collapsible, with a single reflective element, and with image modification by appropriate software. It employs a convex mirror placed next to the rear camera lens within its angular FOV, at a particular angle to direct a wide angular FOV of the frontal horizon into the camera, and delivers such onto the screen, when the mobile device is held in the “walking while texting” position described. To produce the desired effect, there are criteria for both the shape and size of the convex mirror, and for the placement of the convex mirror in respect to the lens of the camera, all being described in details herein. The second component of the invention comprises the appropriate software and modification of the resident software of the particular mobile device, to manipulate the images captured by the camera, and to place these images onto the screen, such that the path and obstacles ahead in the direction of travel are within the user area of visual attention. The third component of the invention comprises a mechanical system, herein called a “tilt assembly”, which holds the convex mirror in the preferred and required position, with capability of safe stowage of the convex mirror. Depending on the design of the mobile device, an additional mechanical positioning system is at times needed to move the “tilt assembly” to the required position next to the camera lens, such as in the case when the lens is positioned along the edge of the rear surface of the mobile device.

In particular, the convex mirror redirects a frontal view of the horizon of the “walking while texting” or similarly engaged device user, into the camera lens while the camera is pointing downwards, with the principal axis of the camera lens being vertical, to 80 degrees from the vertical. This convex mirror is placed at an angle to the back of the device, and adjacent to the camera lens, of a suitable size and curvature to provide a wide angular FOV, with the principal axis of the convex mirror pointing forward and in the same plane as the axis of the camera lens.

Mirror with higher convexity, with a smaller radius of curvature, produces a wider angular FOV. Most mobile devices have camera lenses between 50 and 62 degrees in angular FOV. This is much less than the normal human binocular visual angle of 112 degrees, flanked by another 40 degrees of uniocular fields. Placing a convex mirror with one edge adjacent to the inferior edge of the camera lens, and at an angle of less then 80 degrees with the back of the device (herein termed the ‘tilt angle’), produces a reflected image with a wide-angle FOV of over 100 degrees. The width of the convex mirror has to cover the width of the camera horizontal angular FOV to utilize the full horizontal angular FOV of the camera. For most mobile device cameras, when the radius of curvature of the mirror is less than 5.5 cm, a horizontal angular FOV of over 120 degrees is achieved, comparable to normal human vision, and is about twice as wide as the angular FOV of the camera lens. When this view is shown on part of the screen, or as a background for the lines of messages, the “walking while texting” user has a good wide-angle view of the surroundings of the forward path.

This method of providing a view of the frontal horizon using a convex mirror positioned near the standard rear camera of the mobile device is an improvement over using a second camera attached externally to the mobile devices, as described in U.S. Pat. No. 9,571,803 in terms of simplicity, size, weight and cost of implementation.

The angular FOV of over 120 degrees achieved employing a convex mirror with this invention is an improvement over Kessler's prism system as described in U.S. Pat. No. 9,654,675, and Knapton's system as described in GB Patent 2512145, both provide angular FOV of less than 70 degrees. The disclosure by Rothschild in U.S. Pat. No. 9,128,243, redirects the frontal view to the camera for photographic purposes, and does not increase the angular FOV of the camera lens. The present method is an improvement over that proposed in United States Patent Application 20140085334, which provides a view of the ground a step ahead of the user, and not a redirected frontal view of the foreground.

In addition to the dimensions and the curvature of the convex mirror, there are three other important features with the placement of the mirror on the mobile device, namely, the alignment, the proximity of the convex mirror to the lens, and the angle the backing of the convex mirror makes with the back of the device (the “tilt angle”). The alignment required is for the principal axis of both the convex mirror and the camera lenses to be in the same plane, or close approximation of such. The position of the mirror is within several millimeters from the lower border of the camera lens, to enable most of the camera angular FOV to be covered by the smallest possible convex mirror, for production of a wider frontal view. It is also placed such that the camera lens itself is not in the reflected image. Lastly, the angle of the mirror backing, which is orthogonal to the principal axis of the convex mirror, is most effective at an acute angle to the back of the phone, such that the view straight ahead of the “walking while texting” user can be directed into the lens. This “tilt angle” is dependent on the manner the user holds the mobile device. The approximate relationship between the angle the back (and the screen) of the device makes with the horizon (angle A), and the angle the backing of the convex mirror makes with the back of the device (the tilt angle B) is given by the equation: Angle B=(45 degrees+½(angle A)). When angle A is 90 degrees, the user is holding the screen vertically, which means the user is looking directly ahead, and there is no need for a frontal view on the screen.

The second component of the invention is the software needed to display the wide-angle image of the frontal view of the user thus captured by the camera via the convex mirror on to the screen, either in a dedicated part of the screen, or as the background screen of the ongoing text messages display. Further software modification to remove the opacity of “text bubbles” and the background of the messaging programs increases the visibility of this frontal view. The acquired image can also be processed to detect certain warning signs captured, such as an area of blinking red color created by a flashing red warning light in the foreground, or a moving object. As mobile devices have different operating systems and resident software, the second component involves different modifications for different classes of devices.

The third component of this invention comprises the mechanical structure to secure the convex mirror to achieve the three positioning requirements described above. The convex mirror is held by a “tilt assembly”, which can vary from the simplest fixed bracket to hold the mirror with an adjustable tilt angle, to an assembly of tilt arms and levers on a base, with pivots and fasteners for adjustment of the angles between the arms, the levers, and the mirror. In the deployment position, the combination of the variable angles of the tilt arms with the camera backing, together with the adjustable positions of the mirror pivot pins along the tilt arms, provide different tilt angles for the mirror, which can vary from 45 degrees to about 80 degrees, to suit different users. The reverse manipulation will bring the convex mirror back into the stowage position where it can be locked in place. The arrangement of a base fixed in the middle of the back of the device works well for camera lens positioned in the middle portion of the device, and the base described can be glued down to the rear surface of the mobile device, or attached to the fitted protective cover of the device, or even be a part of the mobile device. Springs can be placed at appropriate parts of the tilt arm assembly to enable one-touch release of the stowed convex mirror, and the return of the mirror to the deployment position.

When the mobile device camera lens is situated off to the side of the rear of the mobile device, a positioning system is needed to move the “tilt assembly”, with an extension on which the aforementioned base of the “tilt assembly” is affixed. The function of this positioning system, the fourth component of this invention, is to bring the base of the “tilt assembly” to the required position below the camera lens, and can consist of a jointed radial arm that can be rotated and extended, or a track along which an extensible arm can slide along to bring the tilt arm assembly to the required position next to the camera lens. The designs of such positioning system aim at keeping the whole apparatus within the boundaries of the plane of the back of the device when stowed.

1. A method which aids navigation of a walking-while-texting or similarly engaged user of personal mobile communication device, whose gaze is directed downwards and unable to see obstacles in the direction of travel, by transferring a wide angle frontal horizontal view onto the mobile device screen, comprising:
(a) a convex reflective surface or mirror placed with one side adjacent to the lower edge of the rear camera lens of the mobile device, tilted at an adjustable acute angle to the rear face of the device, with the width covering most to all of the horizontal angular field of view of the camera lens, and with the principal axis pointing above the horizon in the direction of the travel of the user such that the frontal view of the user is directed into the lens;
(b) software to convert the images from the camera, gathered via the convex mirror, to the upright form, and display these images on to the screen of the mobile device, either by itself, or in combination with some other computer programs in execution;
(c) a tilt assembly of mechanical elements which enables adjustable and appropriate positioning of the said convex mirror in both the deployment mode and the stowage mode, the base of this assembly may or may not be permanently fixed to the mobile device; and
(d) a positioning system for devices with camera lenses located near the edge of the mobile device, capable of moving the base of the tilt assembly from the stowage position to the deployment position below the lens.

2. A preferred embodiment of claim 1 comprises a convex reflective surface or mirror with one or more of the following physical properties:
(a) the width, or horizontal dimension of the convex mirror or reflective surface, is equal or larger than the horizontal angular FOV of the camera lens when deployed;
(b) the radius of curvature is small enough that when placed at the prescribed position, provides a reflected view with an angular field of view of 100 degrees or more of the view in front of the “walking while texting” user;
(c) the shape and vertical dimension for the convex reflective surface or mirror can vary; and
(d) the curvature can be a non-spherical convexity, such as a parabolic curvature; or a non-uniform convexity; or an array of multiple small plane mirrors places in a convex configuration.

3. A preferred embodiment of claim 1 comprises a placement of the convex reflective surface mirror with one or more of the following properties:
(a) the convex reflective surface or mirror is aligned such that the principal axis of both the convex mirror and the camera lenses are in the same plane, or close approximation of such;
(b) the position of the convex reflective surface or mirror is such that the frontal horizon ahead of the user of the mobile communication device is re-directed into the camera lens, and preferably excluding the camera lens itself in the captured image;
(c) the angle between the back of the convex mirror which is orthogonal to the principal axis, and the back of the mobile device is an acute angle, and can be varied depending on the position the user grips the mobile device while “walking while texting”; and
(c) the distance between the proximal edge of the convex mirror and the lower border of the camera lens is less than 10 millimeters, such that the required width of the convex mirror covering the horizontal angular field of view of the camera lens can be minimized.

4. In another embodiment of claim 1, the principal axis of the convex mirror is in a direction other than forward, such that views from the side of the user are presented on the screen, while the user is facing forward.

5. A preferred embodiment of claim 1 where the tilt assembly of mechanical support of claim 1 (c) further comprises one or more of the following objects or properties:
(a) a base, fixed or capable of rotation;
(b) a number of linking arms, connecting levers, pivots and tension devices, to hold the convex mirror firmly in the deployment position;
(c) the ability to maintain adjustable angles and rotation between arms and levers about the pivot;
(d) one or more adjustments for sliding the mirror with its backing along the tilt arms and levers;
(e) the ability to rotate the convex mirror about the distal end of the distal set of arms, such that the described acute angle that the base of the convex mirror making with the back of the camera can be adjusted or fixed as desired; and
(f) the ability to return the convex reflective surface or mirror to a stowage position, either by rotation of the base on the back of the mobile device or by manipulation of the tilt assembly.

6. In certain preferred embodiment of claim 1, the stowage position of the convex mirror has one or more of the following properties:
(a) resting on the rear surface of the mobile device and not protruding beyond the ends and sides;
(b) in close proximity to the rear surface of the mobile device;
(c) with the backing of the convex mirror approximately parallel to the plane of the back of the mobile device;
(d) with the convex mirror facing internally; and
(e) inside a protective enclosure with locking capability.

7. In another preferred embodiment of claim 1, the tilt assembly has provision for an one-push release mechanism, comprising:
(a) knobs and screws on the tilt assembly and mirror to pre-set and fix the convex mirror deployment position and angle,
(b) spring systems which are set into high tension state when the convex mirror is manually returned to the lockable stowage position;
(c) push-button-activated release levers or buttons, which simultaneously unlock the convex mirror from the stowage compartment and also release the catch of the spring system, enabling the springs to bring the convex mirror to the pre-set deployment position.

8. In another preferred embodiment of claim 1, the base of the tilt arm assembly can be attached to the back of the mobile phone, or the back of the mobile phone protective cove, by adhesives, by magnets, or by gripping devices. It can also be an integral part of the protective cover for the mobile device, or part of the back of the mobile device.

9. In another embodiment of claim 1, the base of the tilt assembly can be attached to a “positioning system”, which enables the whole apparatus to fold or collapse into a configuration that fits within the boundaries of the plane of the back of the mobile device for stowage, and able to move the base of the tilt arms assembly to a position just inferior to the camera lens when deployed. This system can be of different designs, including:
(a) design that comprises a sliding track along which an extensible arm slides,
(b) design that comprises a radial arm system capable of rotation and extension.

10. In another preferred embodiment of claim 1, there is appropriate software, as claim in 1(b), with the properties of:
(a) being able to command the operating system and related software of the mobile device to process the view captured by the camera,
(b) being able to organize and rotate the view to the upright alignment,
(c) being able to place this view onto the screen by itself, or simultaneously with the messages of the conversation or displays from other programs; and
(d) ability to modify the messaging software display such that the ‘text bubbles’ are transparent to allow for more information of the captured frontal view to be displayed.
(e) ability to analyze the color and pattern of the pixels of the acquired images for detection of certain conditions, such as the presence of a flashing red light, or a fast moving object in the widened angular field of view, and to provide warnings when required.
